(19) United States
(12) Patent Application Publication
(10) Pub. No.: US 2025/0016240 A1
(43) Pub. Date: Jan. 9, 2025

(54) INFORMATION PROCESSING DEVICE, COMPUTER PROGRAM PRODUCT, AND INFORMATION PROCESSING METHOD

(71) Applicant: KABUSHIKI KAISHA TOSHIBA, Tokyo (JP)

(72) Inventors: Yuta SHIRAKAWA, Kawasaki Kanagawa (JP); Yuto YAMAJI, Kawasaki Kanagawa (JP); Takehiko KAGOSHIMA, Yokohama Kanagawa (JP); Yoshikazu YAMANE, Toshima Tokyo (JP); Mieko ASANO, Kawasaki Kanagawa (JP)

(73) Assignee: KABUSHIKI KAISHA TOSHIBA, Minato-ku, Tokyo (JP)

(21) Appl. No.: 18/441,138

(22) Filed: Feb. 14, 2024

(30) Foreign Application Priority Data
Jul. 4, 2023 (JP) 2023-110202

(51) Int. Cl. H04L 67/50

(52) U.S. Cl. CPC H04L 67/535

(57) ABSTRACT

According to one embodiment, an information processing device includes a hardware processor connected to a memory. The processor reads, from a storage device, information on sensitivity to psychological safety in a communication environment from a storage device. The processor reads, from the storage device, participant information identifying participants who participate in a first communication. The processor reads, from the storage device, first behavioral characteristics information on each of the participants identified by the participant information. The processor calculates influences exerted by the participants on one another. The influences are calculated from the information on the sensitivity to the psychological safety and the first behavioral characteristics information. The processor selects, on the basis of the influences, an advice to improve the psychological safety. The processor notifies a participant to be notified of the advice.

### CROSS-REFERENCE TO RELATED APPLICATIONS

This application is based upon and claims the benefit of priority from Japanese Patent Application No. 2023-110202, filed on Jul. 4, 2023; the entire contents of which are incorporated herein by reference.

### FIELD

Embodiments described herein relate generally to an information processing device, a computer program product, and an information processing method.

### BACKGROUND

There is a growing interest in psychological safety that is reported to be common in productive workplaces. For example, technologies have been known to adjust advices for smoothly conducting a meeting on the basis of sensitivity of participants and give notice to them on the basis of their behavior (for example, Japanese Patent Application Laid-open No. 2022-165118).

However, the conventional technologies have a difficulty in predicting influences on the psychological safety felt by other participants more accurately and give advices more effectively to improve the psychological safety.

### BRIEF DESCRIPTION OF THE DRAWINGS

FIG. 1 is a diagram illustrating an exemplary device configuration of an information processing system according to a first embodiment;

FIG. 2 is a diagram illustrating an exemplary functional configuration of an information processing device according to the first embodiment;

FIG. 3 is a chart illustrating an example of behavioral characteristics of each participant according to the first embodiment;

FIG. 4 is a chart illustrating exemplary sensitivity to psychological safety in a communication environment according to the first embodiment;

FIG. 5 is a flowchart illustrating an exemplary information processing method at the start of or during a communication according to the first embodiment;

FIG. 6 is a chart illustrating a calculation example of influences exerted on other participants according to the first embodiment;

FIG. 7 is a chart illustrating a calculation example of influences received from the other participants according to the first embodiment;

FIG. 8 is a chart illustrating a first example of advices according to the first embodiment;

FIG. 9 is a chart illustrating a second example of the advices according to the first embodiment;

FIG. 10 is a flowchart illustrating an exemplary information processing method after the end of the communication according to the first embodiment;

FIG. 11 is a diagram illustrating exemplary display information according to the first embodiment;

FIG. 12 is a diagram illustrating an exemplary functional configuration of an information processing device according to a second embodiment;

FIG. 13 is a diagram for explaining a process to grasp the behavioral characteristics according to the second embodiment;

FIG. 14 is a flowchart illustrating an exemplary information processing method at the start of and during the communication according to the second embodiment;

FIG. 15A is a chart illustrating an example of usual behavioral characteristics of each participant according to the second embodiment;

FIG. 15B is a chart illustrating an example of actual behavioral characteristics of each participant according to the second embodiment;

FIG. 16 is a diagram illustrating exemplary display information according to the second embodiment;

FIG. 17 is a diagram illustrating an exemplary functional configuration of an information processing device according to a third embodiment;

FIG. 18 is a diagram illustrating an exemplary length of time required for a participant to be notified to return to a variation range of normal behavioral characteristics according to the third embodiment;

FIG. 19 is a diagram illustrating exemplary display information according to a fifth embodiment; and

FIG. 20 is a diagram illustrating an exemplary hardware configuration of the information processing device according to the first to the fifth embodiments.

### DETAILED DESCRIPTION

According to one embodiment, an information processing device includes a hardware processor connected to a memory. The hardware processor is configured to read, from a storage device, information on sensitivity to psychological safety in a communication environment from a storage device. The hardware processor is configured to read, from the storage device, participant information identifying participants who participate in a first communication. The hardware processor is configured to read, from the storage device, first behavioral characteristics information on each of the participants identified by the participant information. The hardware processor is configured to calculate influences exerted by the participants on one another. The influences are calculated from the information on the sensitivity to the psychological safety and the first behavioral characteristics information. The hardware processor is configured to select, on the basis of the influences, an advice to improve the psychological safety. The hardware processor is configured to notify a participant to be notified of the advice.

The following describes embodiments of a computer program, an information processing device, and an information processing method in detail with reference to the accompanying drawings.

### First Embodiment

In a first embodiment, a description will be made by exemplifying an information processing system that operates as a meeting support system. This information processing system is not limited to being targeted at remote meetings, off-line meetings, and the like, but can be targeted at any communication.

### Exemplary Device Configuration

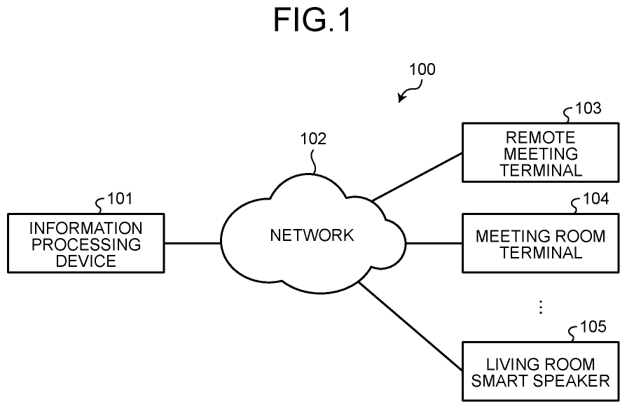

FIG. 1 is a diagram illustrating an exemplary device configuration of the information processing system 100 according to the first embodiment. An information processing system 100 of the first embodiment includes an information processing device 101 and client devices such as a remote meeting terminal 103, a meeting room terminal 104, and a living room smart speaker 105. The information processing device 101 and the client devices are connected via a network 102, such as the Internet.

The communication method of the network 102 may be a wired method or a wireless method. The network 102 may be configured by combining the wired method with the wireless method.

The remote meeting terminal 103 is, for example, a personal computer in which a remote meeting application is installed. The meeting room terminal 104 is, for example, a terminal equipped in a meeting room. The living room smart speaker 105 is, for example, a smart speaker that assists stand talking in a living room.

The information processing device 101 of the first embodiment provides functions of the meeting support system to the remote meeting terminal 103, the meeting room terminal 104, the living room smart speaker 105, and so forth via the network 102.

### Exemplary Functional Configuration

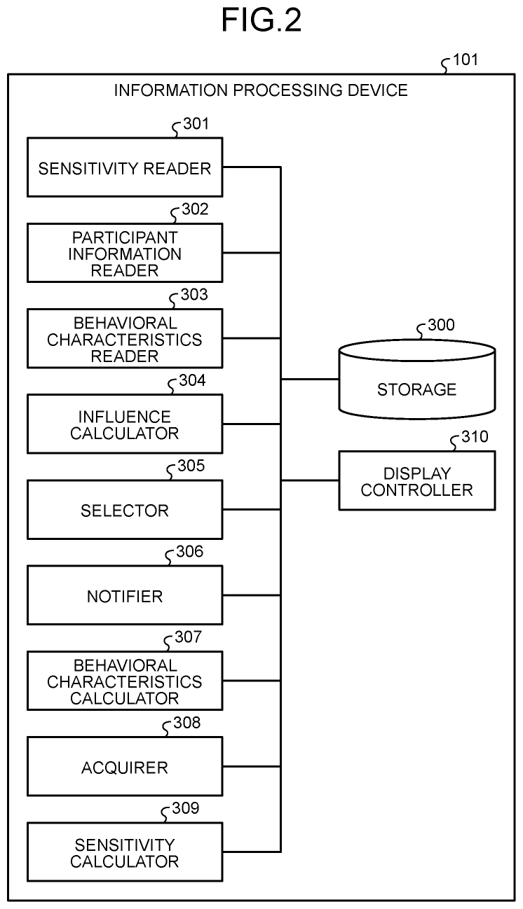

FIG. 2 is a diagram illustrating an exemplary functional configuration of the information processing device 101 according to the first embodiment. The information processing device 101 of the first embodiment includes a storage 300, a sensitivity reader 301, a participant information reader 302, a behavioral characteristics reader 303, an influence calculator 304, a selector 305, a notifier 306, a behavioral characteristics calculator 307, an acquirer 308, a sensitivity calculator 309, and a display controller 310.

The storage 300 is a storage device that stores various types of information. The storage 300 stores in advance, for example, behavioral characteristics of each user in communication and sensitivity of each user to psychological safety received from other participants. The storage 300 also stores, for example, behavioral data of participants in past communications. The storage 300 also stores, for example, the psychological safety felt by each of the participants during the communication, for each of the communications such as the meetings.

The behavioral characteristics and the sensitivity are updated by, for example, the behavioral characteristics calculator 307, the acquirer 308, and the sensitivity calculator 309 at the end of each of the communications in which each user is participating. Details of a method for updating will be described later For example, the behavioral characteristics and the sensitivity are set by a user at the time of initial use of the information processing device 101.

The sensitivity reader 301 reads information on the sensitivity to the psychological safety in the communication environment from the storage 300. The information on the sensitivity to the psychological safety will be described later.

The participant information reader 302 reads participant information for identifying a plurality of participants who participate in the communication from the storage 300. In one example, at the time when holding a meeting A and the participants of the meeting A have been determined, the participant information reader 302 reads the participant information indicating that the users, Suzuki, Yamada, and Sato will participate in the meeting A from the storage 300.

The behavioral characteristics reader 303 reads behavioral characteristics information on each of the participants identified by the participant information from the storage 300.

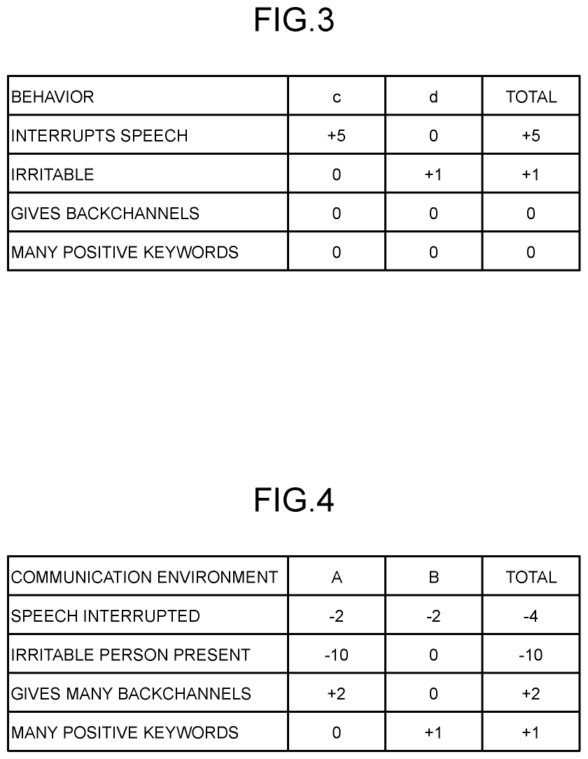

FIG. 3 is a chart illustrating an example of the behavioral characteristics of each of the participants according to the first embodiment. The behavioral characteristics of each of the participants are indicated by information (such as a numerical value) representing, along at least one indicator for property, the degree of the corresponding property. Examples of the indicators for the behavioral characteristics include “interrupts speech”, “long speech”, “many positive keywords”, “many negative keywords”, “irritable”, and “gives backchannels”.

In the example in FIG. 3, “interrupts speech”, “irritable”, “gives backchannels”, and “many positive keywords” are used as the indicators. For example, a participant c is higher in the degree of “interrupts speech” than an ordinary person (0) because the degree of “interrupts speech” is indicated as +5.

The behavioral characteristics of each of the participants may be indicated not as a numerical value that represents the degree of strength of the corresponding property, but as a logical value (0 or 1) that represents the presence or absence of the corresponding property.

Referring back to FIG. 2, the influence calculator 304 calculates the influence exerted by the participants on one another, by using the sensitivity to the psychological safety in the communication environment and the behavioral characteristics of each of the participants.

The selector 305 selects an advice to improve the psychological safety on the basis of the influence calculated by the influence calculator 304.

The notifier 306 notifies a participant to be notified of the advice (namely, a participant who should receive the advice) selected by the selector 305.

The behavioral characteristics calculator 307 calculates the behavioral characteristics of each of the participants by using the behavioral data in the past communications (second communications). The behavioral characteristics of the participant can be calculated by the behavioral characteristics calculator 307, instead of being set by the user, on the basis of the past behavior identified from the behavioral data.

For example, the indicator “interrupts speech” is quantified by calculating the frequency at which the participant in question starts talking while another participant continues speaking (frequency of turn-taking) on the basis of speech and behavior data during a meeting. Specifically, the behavioral characteristics calculator 307 identifies a speaker a of the speech from video information, determines whether the speaker a is speaking or has finished speaking on the basis of the inflection and interval of the speech, and when another speaker b starts speaking while the speech is made, records that the speaker b interrupted the speech once. The behavioral characteristics calculator 307 sums up the number of events in which each of the speakers interrupts in the same manner and normalizes the result by the length of the meeting time, thus, calculating the frequency per unit time at which each of the speakers interrupts.

For example, the indicator “long speech time” that is an indicator as to whether a speaking time is long or short is quantified by using a continuous speaking time from the speech and behavior data during the meeting. Specifically, the behavioral characteristics calculator 307 quantifies the continuous speaking time by measuring, from the video information, the speaking time of the speaker a and measuring the time until a person other than the speaker a starts speaking. The behavioral characteristics calculator 307 calculates the speaking ratio per unit meeting by normalizing the quantified continuous speaking time by the length of the meeting.

For example, the indicator “many positive keywords” is quantified by the number of times of occurrence of positive keywords per speaking time or per meeting time. Specifically, the behavioral characteristics calculator 307 converts the content of speech into text information by applying a speech content recognizer to the speech and behavior data during the meeting, and collates the text information with predetermined positive keywords. As a result, the number of times of occurrence of positive keywords per speaking time or per meeting time can be calculated.

The positive keywords are keywords that indicate agreements, such as “That is a good statement” and “Please proceed as is”.

In the same manner, the indicator “many negative keywords” is quantified by measuring the frequency of occurrence of negative keywords.

The negative keywords are keywords that indicate negation, such as “It's no good” and “Please reconsider”.

The indicators for these behavioral characteristics are not limited to the examples mentioned above, and any indicator indicating how to behave in communication can be used. Any method for quantifying the behavioral characteristics may be used.

FIG. 4 is a chart illustrating an example of the sensitivity to the psychological safety in the communication environment according to the first embodiment. The sensitivity to the psychological safety includes information that is evaluated on the basis of the indicator for the property of the behavior of the participant in the communication environment and indicates the degree of increase or decrease in the psychological safety in the communication environment. For example, as illustrated in FIG. 4, the sensitivity calculator 309 calculates the sensitivity to the psychological safety by using the indicators for the communication environments that indicate, in past meetings in which the participants participated, how many participants in the same meetings have exhibited the corresponding behavioral characteristics, and information on what types of psychological safety were felt for the meetings. Each of the indicators for evaluating the communication environments is quantified by the total value of the indicators for the behavioral characteristics of the participants (for example, the participants in the same meetings). The sensitivity to the psychological safety is expressed by numerical values along several indicators, as illustrated in FIG. 4. Each of the numerical values represents the degree to which the psychological safety increases or decreases with respect to the corresponding surrounding environment. A positive value represents the degree to which the psychological safety is improved, and a negative value represents the degree to which the psychological safety is lowered.

The example in FIG. 4 illustrates the sensitivity based on the communication environment, indicating how participants A and B feel the psychological safety about the communication environment. The total value is also illustrated for the case where the participants A and B are present in the same meeting. The sensitivity to the psychological safety is quantified by the total value of the sensitivity of the participants.

The example in FIG. 4 uses “speech interrupted”, “irritable person present”, “many backchannels”, and “many positive keywords” as the indicators for the behavioral characteristics.

For example, since the indicator of the participant A for “irritable person present” is −10, the psychological safety of the participant A turns out to be easily lowered when an irritable person is present.

In the example in FIG. 4, the sensitivity to the psychological safety when the participants A and B are present in the same meeting is quantified by the total value of the sensitivity of the participants A and B.

The sensitivity is stored in the storage 300 as numerical values of degrees that indicate to what degrees the psychological safety of the corresponding participants increase or decrease with respect to the surrounding environment along the several indicators, as illustrated in FIG. 4.

The acquirer 308 measures the psychological safety. The acquirer 308 acquires the psychological safety felt by each of the participants during the communication, and stores the acquired psychological safety in the storage 300 so as to be associated with information for identifying the user.

The psychological safety is generally considered to be fostered in a communication environment from the following points of view.

(1) If you make a mistake in a team, you are usually blamed.

(2) Team members can point out issues and difficult problems to one another.

(3) Team members sometimes reject others because they are different from themselves.

(4) It is safe to take risky actions toward the team.

(5) It is difficult to ask other members of the team for help.

(6) No members of the team intentionally act in a way of degrading their own work.

(7) When working with team members, I feel that my skills and talents are respected and put to good use.

### (Source: Google Re: Work-Guide: Know “What Makes an Effective Team”)

The acquirer 308 acquires the psychological safety of each of the participants, for example, by detecting contents of the above-listed items (1) to (7) through video recognition, voice recognition, and biometric recognition. For example, the acquirer 308 quantifies the item (1) by analyzing the content of the statement of the participant in the same meeting after the report about the mistake. For example, the acquirer 308 may also acquire the psychological safety at this meeting from the user through a post-meeting questionnaire.

For example, the acquirer 308 may also acquire a quantitative value of the psychological safety by analyzing the length of the speaking time, the number of times of hesitation in speech, and the number of times of appeasement behavior such as placing the hands on the chest, through the voice recognition, the video recognition, and the biometric recognition. Specifically, the acquirer 308 makes determination that the psychological safety is low/high if the speaking time during a target meeting is shorter/longer than the average speaking time during typical meetings (such as regular meetings) in which the user has participated in the past.

The sensitivity calculator 309 calculates parameters of the sensitivity, such as “speech interrupted”, “irritable person present”, “many backchannels”, and “many positive keywords”. These parameters of the sensitivity are calculated by using the indicators for the communication environments that indicate, at past meetings in which the participants participated, how many participants in the same meetings have exhibited the corresponding behavioral characteristics, and information on what types of psychological safety were felt for the meetings.

For example, after the communication has ended, the sensitivity calculator 309 calculates the information on the sensitivity to the psychological safety by using a psychological safety model obtained by modeling a relation among the psychological safety acquired by the acquirer 308, the indicator for the communication environment, and the information on the sensitivity to the psychological safety.

The following illustrates an exemplary case where the relation among the psychological safety, the sensitivity, and the communication environment in the sensitivity calculator 309 is modeled as a linear model by the system (for example the sensitivity calculator 309). The system that performs the modeling may be a device other than the information processing device 101.

Psychological safety y felt by the user at a certain meeting is estimated by totaling a score obtained by multiplying sensitivity aᵢ for an i-th indicator modeled by the system by an indicator xi of the corresponding communication environment for all indicators iϵI used for the modeling (Expression (1) below).

$$y = {\sum }_{\text{?} ∈ \text{?}} {a}_{\text{?}} * {x}_{\text{?}} \qquad ( 1 )$$

$$\text{?} \text{indicates text missing or illegible when filed}$$

The sensitivity aᵢ that minimizes the differences between correct values y″ⱼ of the psychological safety analyzed at the past meetings jϵJ and yⱼ estimated by the system is adjusted by Expression (2) below.

$$Error = {\sum }_{\text{?} ∈ \text{?}} \vert {y}_{\text{?}} - {\tilde{y}}_{\text{?}} \vert \qquad ( 2 )$$

$$\text{?} \text{indicates text missing or illegible when filed}$$

The model representing the relation among the psychological safety, the sensitivity, and the communication environment is not limited to the linear model, but may be expressed by any modeling.

As a variation of the modeling, for example, an influence bₖ due to the average behavioral characteristics (work climate) of each workplace k may be added as a bias for the communication environment. For example, an offset cᵢ may be added to indicate a way of feeling by a particular person with respect to the indicator i. For example, an offset d may be added to indicate ease of feeling of the psychological safety by a particular person independently of the indicator.

An example of the variation of the modeling is represented by Expression (3) below.

$$y = d + {\sum }_{\text{?} ∈ \text{?}} ( {a}_{\text{?}} * ( {x}_{\text{?}} + {b}_{k} ) + {c}_{\text{?}} ) \qquad ( 3 )$$

$$\text{?} \text{indicates text missing or illegible when filed}$$

One or some of the influence bₖ, the offset cᵢ, and the offset d may be used for the modeling.

Thus, in the first embodiment, the sensitivity calculator 309 can calculate the information on the sensitivity to the psychological safety using the psychological safety model on the basis of the indicators of the communication environments (such as the meetings) in which the user has participated in the past and the psychological safety felt on those occasions, without the user himself/herself having to set the information on the sensitivity.

### Exemplary Information Processing Method

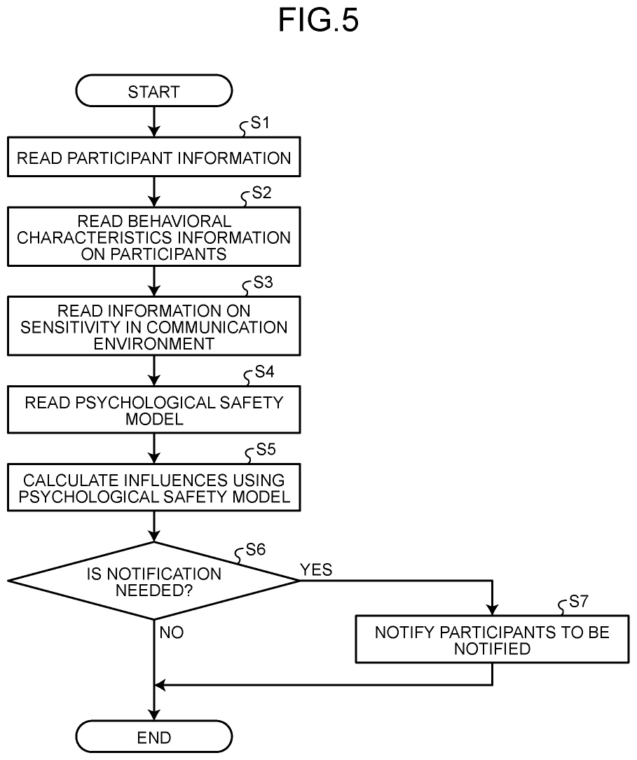

FIG. 5 is a flowchart illustrating an exemplary information processing method before the start of the communication according to the first embodiment. First, the participant information reader 302 reads the participant information for identifying the participants who participate in the communication from the storage 300 (Step S1).

The behavioral characteristics reader 303 reads the behavioral characteristics information on each of the participants identified by the participant information from the storage 300 (Step S2).

The sensitivity reader 301 reads the information on the sensitivity to the psychological safety in the communication environment from the storage 300 (Step S3).

The influence calculator 304 reads the psychological safety model described above from the storage 300 (Step S4).

The influence calculator 304 then calculates, by using the psychological safety model, the influences exerted by the participants on one another from the information on the sensitivity to the psychological safety in the communication environment and the behavioral characteristics information on each of the participants, (Step S5).

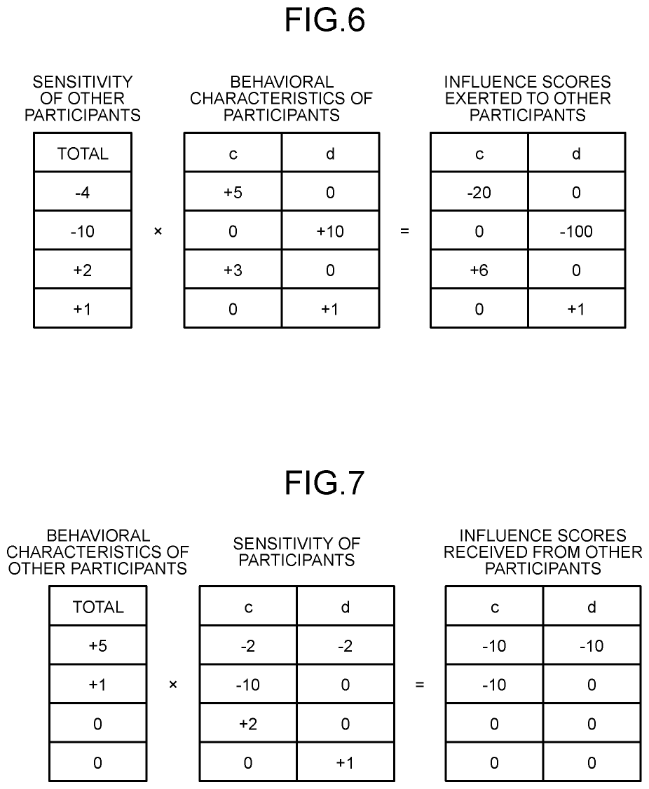

FIG. 6 is a chart illustrating a calculation example of the influences exerted on other participants according to the first embodiment. The example in FIG. 6 illustrates the influences exerted on the other participants by the participant c and a participant d as scores calculated based on the psychological safety model expressed as the linear model. The sensitivity of the other participants indicates the total of the sensitivity of the participants other than the participant c, and corresponds to the total of the exemplary sensitivity in FIG. 4 explained above. For example, in the case of the indicator for the behavioral characteristics “speech interrupted” (+5) of the participant c, the influence score exerted to the other participants by the participant c is (−4)×(+5)=(−20).

FIG. 7 is a chart illustrating a calculation example of the influences received from the other participants according to the first embodiment. The example in FIG. 7 illustrates the influences received by the participants c and d from the other participants as scores. The example in FIG. 7 illustrates the influences received by the participants c and d from the other participants as the scores calculated based on the psychological safety model expressed as the linear model. The behavioral characteristics of the other participants represent the total of the behavioral characteristics of the participants except the participant c. For example, in the case of the indicator for the sensitivity “speech interrupted” (−2) of the participant c, the influence score received by the participant c from the other participants is (+5)×(−2)=(−10).

Referring back to FIG. 5, the selector 305 then determines whether a participant needs to be notified on the basis of the influences calculated at Step S5 (Step S6). Specifically, the selector 305 selects, with reference to the storage 300, an advice to be presented to the participant on the basis of the influences calculated at Step S5. If an advice to be presented is present, determination is made such that the advice needs to be presented to the participant to be notified.

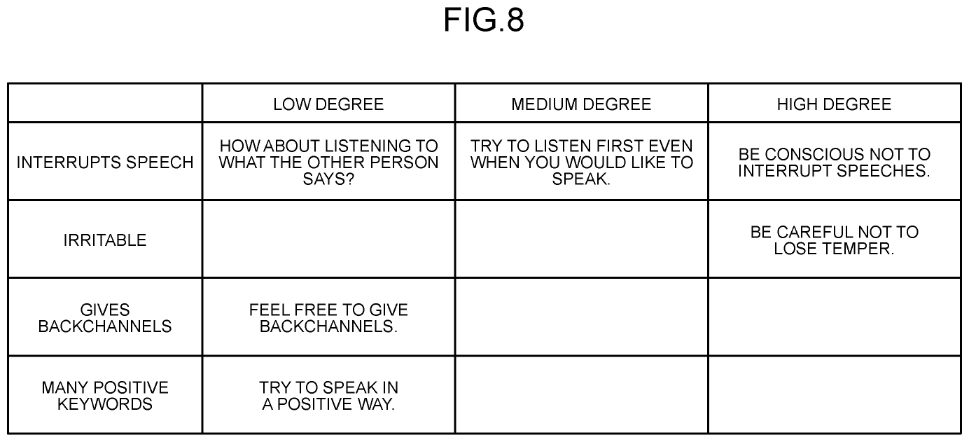

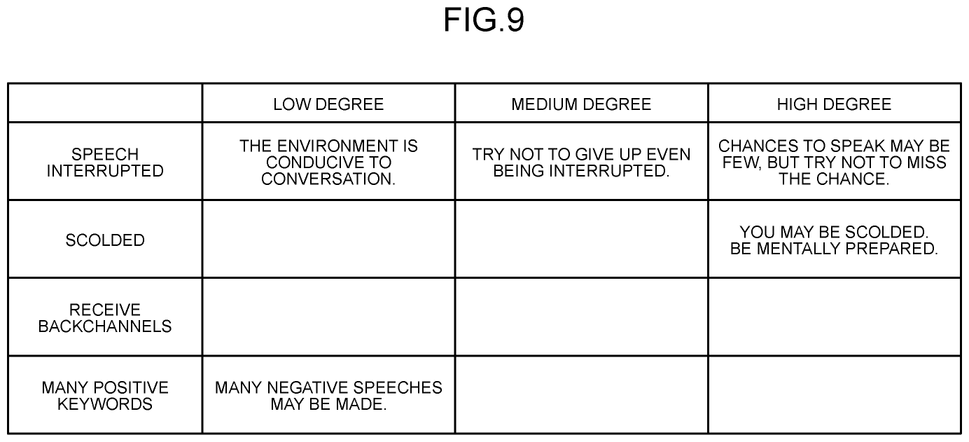

FIG. 8 is a chart illustrating a first example of the advices according to the first embodiment. FIG. 9 is a chart illustrating a second example of the advices according to the first embodiment. The advices corresponding to the degree of influence of various indicators for the behavioral characteristics have been stored in the storage 300, as illustrated in FIGS. 8 and 9.

In the examples in FIGS. 8 and 9, the advices are stored in a database divided into three categories (low degree, medium degree, and high degree) depending on the magnitude of the influence score (degree of influence). The categories may be any number of categories such as two categories or five categories instead of the three categories of low, medium, and high degrees, or no categorization may be made. Advices based on a continuous value N may also be provided, such as “If you feel like getting angry, count N seconds”.

The advices may be registered by the user, or otherwise delivered by a service provider from a network.

The selector 305 selects one or more of the advices stored in the database. For example, the selector 305 selects, as the participant to be notified, a participant for whom the top one score is calculated among the scores for influences received by the participants from the other participants, and selects an advice in a category corresponding to the top one influence score.

For example, the selector 305 selects, as the participant to be notified, a participant for whom the top one score is calculated among the scores for influences exerted by the participants to the other participants, and selects an advice in a category corresponding to the top one score.

The selection of advice is not limited to selecting the advice corresponding to the top one score, but may be selecting advices corresponding to top n scores. Not only the advices for the category corresponding to the top scores but also advices for a category corresponding to bottom scores may be selected.

Referring back to FIG. 5, if advices are needed (Yes at Step S6), the notifier 306 presents the advices to one or more participants to be notified (Step S7). If no advice is needed (No at Step S6), the process ends.

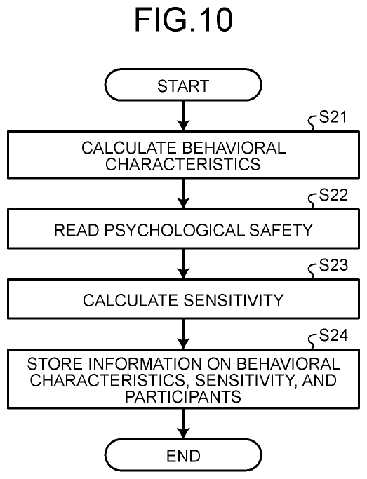

FIG. 10 is a flowchart illustrating an exemplary information processing method after the end of the communication according to the first embodiment. First, the behavioral characteristics calculator 307 calculates the behavioral characteristics from the behavioral data of each of the participants in a communication (for example, the meeting A) after the communication ends (Step S21).

The acquirer 308 reads the psychological safety felt by the participants during the communication from the storage 300 (Step S22). The psychological safety of the participants is periodically acquired by the acquirer 308 and stored in the storage 300, for example, during the communication.

The sensitivity calculator 309 calculates the sensitivity in the communication from the behavioral characteristics calculated at Step S21 and the psychological safety read at Step S22 (Step S23).

The storage 300 stores the information indicating the behavioral characteristics calculated at Step S21 and the information indicating the sensitivity calculated at Step S23, together with the participant information for identifying the participants (Step S24).

Referring back to FIG. 2, the display controller 310 controls the client devices and other devices to display information.

### Exemplary Display Information

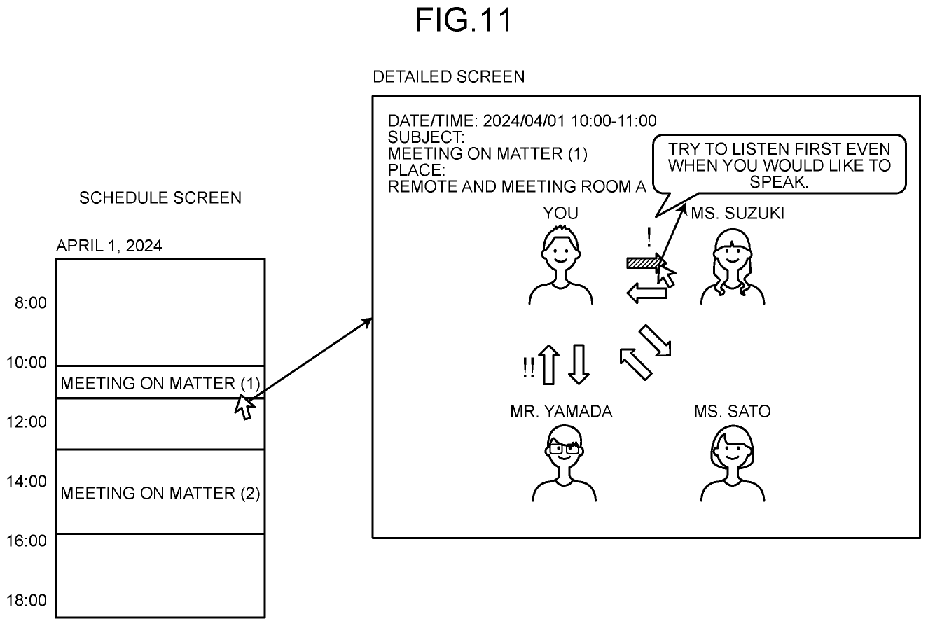

FIG. 11 is a diagram illustrating exemplary display information according to the first embodiment. The example in FIG. 11 illustrates a case where the above-described function of notification of advices is incorporated in a user interface (UI) screen of a schedule management application.

In the example in FIG. 11, the display controller 310 displays a detailed screen after receiving a click on a certain schedule on a schedule screen. The detailed screen indicates details of the schedule and a relation of a participant scheduled to participate in the same meeting with the user.

The example in FIG. 11 illustrates a case where four participants (user, Suzuki, Yamada, and Sato) are to participate in the communication. Arrows on the detailed screen indicate influences exerted on each other. When the influence exceeds a predetermined degree, the display controller 310 displays the display information (first display information) with an icon superimposed thereon to highlight the notification on a display device. In the example in FIG. 11, an arrow for a relation that exerts an influence of a certain degree or more is highlighted by an icon of !-mark. A corresponding advice is displayed by, for example, a mouse-over operation over the arrow highlighted by the !-mark. Thus, the notification can be highlighted so as to attract attention of the user when the attention is particularly needed.

The form of the communication is not limited to the meeting, but may include one-on-one talking, a regular event, a presentation, stand talking, and talking on the phone. The scale of the communication may be any scale. The communication may be performed online, or in a hybrid meeting that includes users participating online and users participating face-to-face.

As described above, in the information processing device 101 of the first embodiment, the sensitivity reader 301 reads the information on the sensitivity to the psychological safety in the communication environment from the storage device (in the first embodiment, the storage 300). The participant information reader 302 reads the participant information for identifying the participants who participate in a first communication from the storage device. The behavioral characteristics reader 303 reads first behavioral characteristics information on each of the participants identified by the participant information from the storage device. The influence calculator 304 calculates the influences exerted by the participants on one another from the information on the sensitivity to the psychological safety and the first behavioral characteristics information. The selector selects advices to improve the psychological safety based on the influences. The notifier 306 then notifies participants to be notified of the advices.

Thus, according to the first embodiment, the influences on the psychological safety felt by the other participants can be accurately predicted, and the advices to improve the psychological safety can be presented as notification more effectively. For example, the influence on each of the participants can be predicted in advance from the behavioral characteristics information on each of the participants and the information on the sensitivity to the psychological safety in the communications such as the meetings. Specifically, participants who feel psychologically unsafe can be advised before being brought into an unsafe situation and encouraged to respond calmly. Participants who cause damage by driving other participants into unsafe situation can be given an advice in a calm mindset in advance. As a result, an effect is obtained that provides an opportunity for efficient review of the communications.

In conventional technologies, for example, the advices are determined by the speech and behavior data and advice rules. Therefore, adjustment by combination of the participants in the same meeting does not work. An adequate advice could not be given to the participants on the basis of the sensitivity to the psychological safety of each of the participants: “How did the participants feel when they received the speech and behavior?”.

In contrast, according to the first embodiment, by modeling the sensitivity to the psychological safety based on the behavior of the other participants, the advice can be given at a prior time when the participant information is determined. That is, the advice can be given before a participant is brought into a psychologically unsafe situation, and the participant can be given time to be mentally prepared in advance. In addition, the participants who cause damage by driving other participants into unsafe situation can be given an advice in a calm mindset in advance, and can be encouraged to efficiently review the behavioral characteristics.

### Second Embodiment

The following describes a second embodiment. In the description of the second embodiment, the same description as that of the first embodiment will not be made, and differences from the first embodiment will be described. The second embodiment differs from the first embodiment in terms of further having a function to grasp the actual behavioral characteristics on the basis of the information during the communication.

### Exemplary Functional Configuration

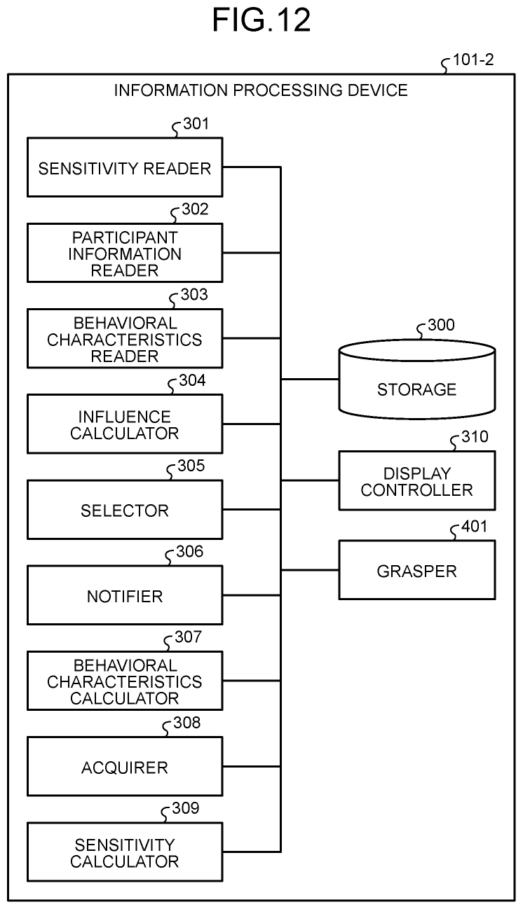

FIG. 12 is a diagram illustrating an exemplary functional configuration of an information processing device 101-2 according to the second embodiment. The information processing device 101-2 of the second embodiment further includes a grasper 401 in addition to the components of the information processing device 101 of the first embodiment.

The grasper 401 grasps the behavioral characteristics (second behavioral characteristics information) of the participants during the communication (for example, during the meeting) from the states of the participants during the communication. While the behavioral characteristics calculator 307 of the first embodiment calculates the behavioral characteristics (first behavioral characteristics information) from the behavioral data of each of the participants in the past meetings, the grasper 401 of the second embodiment calculates the behavioral characteristics at a certain frequency or at all times without waiting for the end of the meeting.

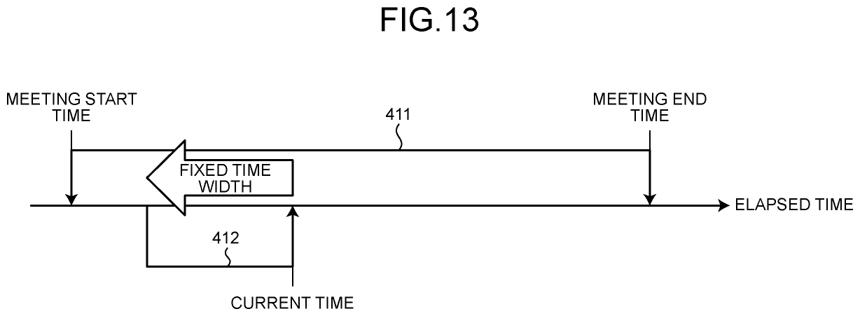

FIG. 13 is a diagram for explaining a process to grasp the behavioral characteristics according to the second embodiment. A period 411 from a meeting start time to a meeting end time represents a period for which the behavioral characteristics calculator 307 calculates the behavioral characteristics of the participants.

By using a sliding window having a fixed time width 412 before the current time as an input window, the grasper 401 cuts out a time period for grasping the states of the participants, and calculates the behavioral characteristics of the participants for the cut out time period. As a result, the behavioral characteristics of the participants can be grasped without waiting the end of the meeting.

The method for calculating the behavioral characteristics by the grasper 401 may differ from the method for calculating the behavioral characteristics by the behavioral characteristics calculator 307. For example, the model and coefficients used to calculate the behavioral characteristics may differ between the grasper 401 and the behavioral characteristics calculator 307.

### Exemplary Information Processing Method

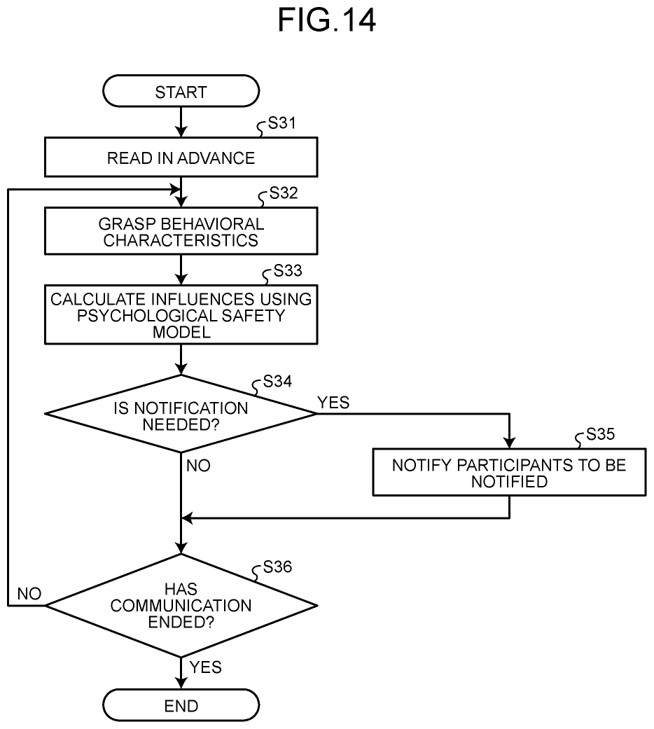

FIG. 14 is a flowchart illustrating an exemplary information processing method at the start of and during the communication according to the second embodiment. First, the participant information reader 302, the behavioral characteristics reader 303, the sensitivity reader 301, and the influence calculator 304 read the participant information, the behavioral characteristics information, the information on the sensitivity to the psychological safety, and the psychological safety model in advance (Step S31).

The grasper 401 grasps the behavioral characteristics of the participants from on the basis of the states of the participants during the communication (for example, during the meeting) (Step S32).

The influence calculator 304 calculates the influences exerted by the participants on one another, by using the psychological safety model, on the basis of the information on the sensitivity to the psychological safety in the communication environment and the behavioral characteristics information on each of the participants grasped at Step S32 (Step S33).

The selector 305 determines whether a participant needs to be notified on the basis of the influences calculated at Step S33 (Step S34). In the second embodiment, the timing of determining that the notification is necessary (timing of notifying the participant to be notified) may be changed in consideration of the influence based on the behavioral characteristics during the communication.

Specifically, the selector 305 determines the timing of notifying the participant to be notified on the basis of usual behavioral characteristics and the behavioral characteristics during the communication, and selects an advice at the time of the notification. For example, the selector 305 selects the advice when the second behavioral characteristics information mentioned above exhibits a change exceeding a threshold set on the basis of the first behavioral characteristics information mentioned above.

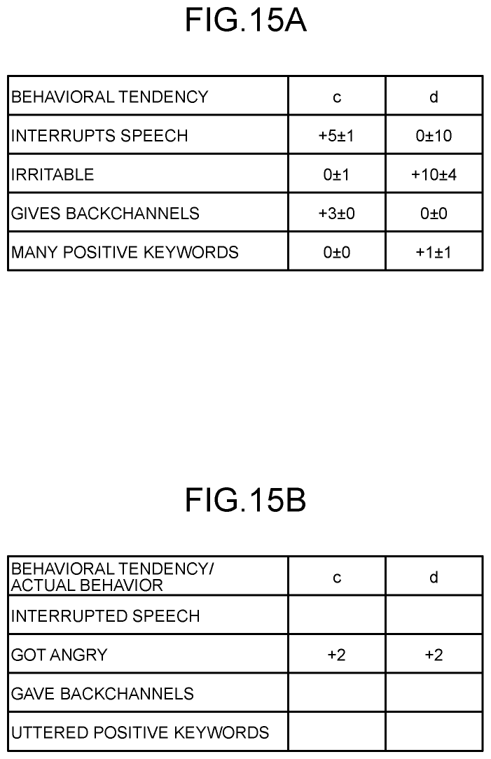

FIG. 15A is a chart illustrating an example of the usual behavioral characteristics of each of the participants according to the second embodiment. In the example in FIG. 15A, each of the usual behavioral characteristics is represented by an average behavioral characteristic value and a variance. For example, in the case of the indicator for “irritable”, the usual behavioral characteristic of the participant c is represented by the average behavioral characteristic value of 0 and the variance of +1.

FIG. 15B is a chart illustrating an example of the actual behavioral characteristics (behavioral characteristics acquired during communication) of each of the participants according to the second embodiment. The selector 305 selects the advice when the behavioral characteristics acquired during the communication exhibit a change exceeding a threshold set on the basis of the usual behavioral characteristics. The threshold is determined, for example, by considering the variance of the usual behavioral characteristics. For example, in the case of the participant c, the threshold is 1 because the usual behavioral characteristic is 0±1. In the example in FIG. 15B, the actual behaviors characteristic of the participant c is +2, and therefore exceeds the threshold=1. Therefore, the selector 305 selects an advice for the participant c.

As a result, in a case where a person who usually frequently gets angry (the participant d in the example in FIG. 15A) is about to get angry and a case where a person who usually does not get angry easily (the participant c in the example in FIG. 15A) is about to get angry, even the person in the latter case can be notified of the advice earlier.

Referring back to FIG. 14, if advices are needed (Yes at Step S34), the notifier 306 presents the advices to one or more participants to be notified (Step S35).

If no advice is needed (No at Step S34), the grasper 401 determines whether the communication has ended (Step S36). If the communication has not ended (No at Step S36), the process at Steps S32 to S36 is repeated at predetermined fixed intervals. If the communication has ended (Yes at Step S36), the process ends.

### Exemplary Display Information

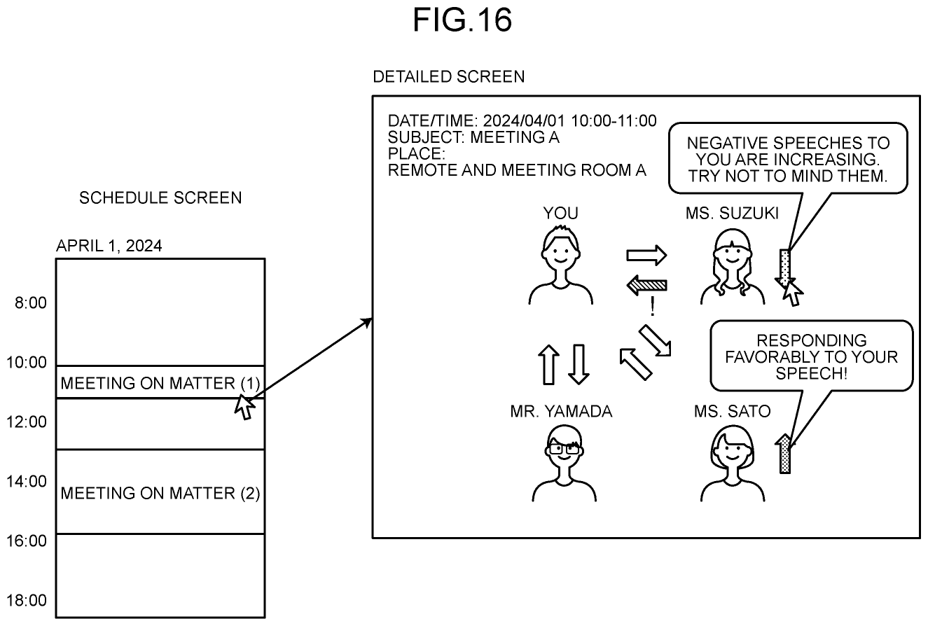

FIG. 16 is a diagram illustrating exemplary display information according to the second embodiment. The example in FIG. 16 illustrates a case where the above-described function of the notification of the advices is incorporated in the UI screen of the schedule management application. On the detailed screen of the second embodiment, a state of improvement or deterioration is indicated by an up or down arrow for a person whose behavioral characteristic has been updated during the communication.

The influences exerted on each other are indicated by arrows, in the same manner as in the first embodiment. The arrow for a relation that exerts an influence of a certain degree or more is highlighted by the !-mark. A corresponding advice is displayed by, for example, a mouse-over operation over the arrow.

As described above, the second embodiment allows more timely notification of advice to be made on the basis of the behavioral characteristics of the participant estimated from the past behavioral tendency and the behavioral characteristics calculated from the behavior in the current communication (more reality-based behavioral characteristics). That is, more timely notification of advice can be made on the basis of not only the predefined behavioral characteristics and the past tendency, but also the actual behavioral characteristics and the sensitivity of the other participants in the actual communication.

### Third Embodiment

The following describes a third embodiment. In the description of the third embodiment, the same description as that of the first embodiment will not be made, and differences from the first embodiment will be described. The third embodiment differs from the second embodiment in terms of further having a function to adjust the advice stored in the storage 300 on the basis of whether a change in behavioral characteristics has occurred between before and after the notification of the advice.

### Exemplary Functional Configuration

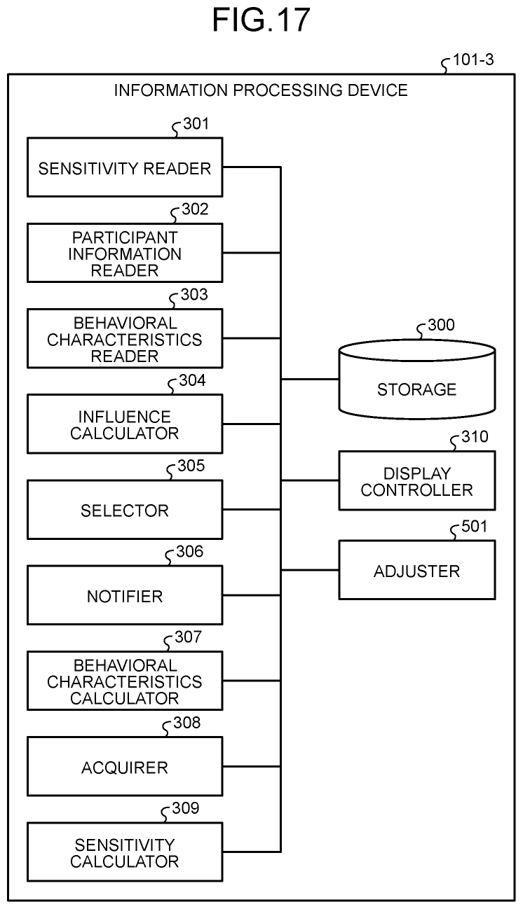

FIG. 17 is a diagram illustrating an exemplary functional configuration of an information processing device 101-3 according to the third embodiment. The information processing device 101-3 of the third embodiment further includes an adjuster 501 in addition to the components of the information processing device 101 of the first embodiment.

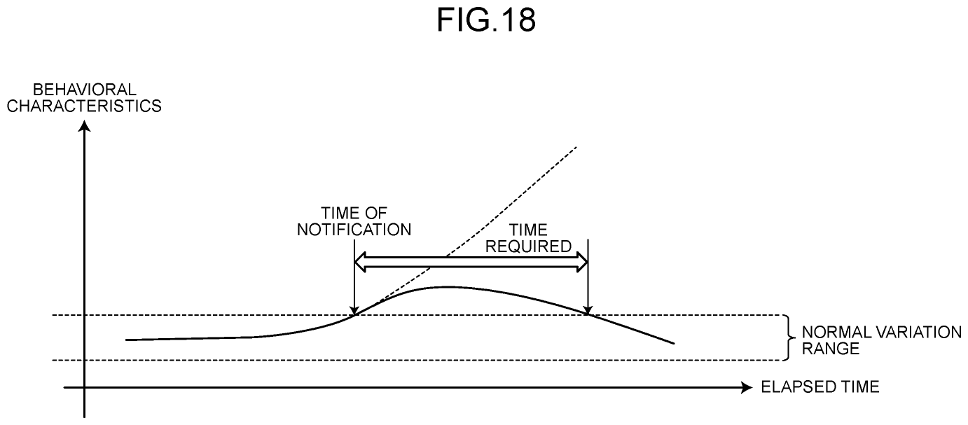

The adjuster 501 adjusts the advice to be presented as a notification to the participant to be notified, on the basis of whether a change in behavioral characteristics of the participant to be notified has occurred between before and after the notification of the advice. For example, the adjuster 501 adjusts the strength of the advice on the basis of the length of time until the advice presented as a notification by the notifier 306 takes effect. Specifically, based on the length of time required from the time of notification of the advice until the behavioral characteristics return to a variation range of the normal behavioral characteristics of the participant to be notified (refer to FIG. 18), the adjuster 501 adjusts the strength of the advice to be presented as a notification when the participant to be notified falls under the same advice conditions from the next time onward.

FIG. 18 is a diagram illustrating an exemplary length of time required for a participant to be notified to return to the variation range of the normal behavioral characteristics according to the third embodiment. The adjustment is made by changing an advice to an advice away therefrom by one or more categories in FIGS. 8 and 9 explained above. For example, the adjuster 501 makes an adjustment to give a high-degree advice if the time required to take effect is longer than a predetermined length of time even if the influence exerted by the participant to be notified on the other participants (or the influence received by the participant to be notified from the other participants) is at a medium degree. In contrast, the adjuster 501 makes an adjustment to give a low-level advice if the time required to take effect is shorter than the predetermined length of time even if the influence exerted by the participant to be notified on the other participants (or the influence received by the participant to be notified from the other participants) is at a medium degree.

The third embodiment can adjust the strength of the advice for each of the users (such as the participants of the meeting) according to whether the behavior has changed in response to the advice, thus being capable of preventing the advice from giving too much or too little feedback.

### Fourth Embodiment

The following describes a fourth embodiment. In the description of the fourth embodiment, the same description as that of the first embodiment will not be made, and differences from the first embodiment will be described. The fourth embodiment differs from the first embodiment in terms of use of conditional behavioral characteristics and conditional sensitivity.

The behavioral characteristics reader 303 of the fourth embodiment reads the conditional behavioral characteristics in addition to the behavioral characteristics of the participant alone. Even the sensitivity of the same participant may vary depending on the combination with the other participants. The conditional behavioral characteristics are behavioral characteristics based on the combination of participants participating in the communication.

The conditional behavioral characteristics may include behavioral characteristics that vary depending on the combination with specific attributes (such as a supervisor, a team member, a new employee, a senior, and gender), as well as the combination with specific people.

The behavioral characteristics of the first embodiment are calculated from the behavior in past situations of communication. In contrast, the conditional behavioral characteristics are calculated by aggregating the behavioral characteristics in the situations of communication that satisfy predetermined conditions (such as a combination of participants in the same meeting) on the basis of the participant information and the behavioral characteristics information stored in the storage 300. That is, in the fourth embodiment, the behavioral characteristics calculator 307 calculates the conditional behavioral characteristics for each of the situations of communication that satisfy the predetermined conditions.

Similarly, the sensitivity reader 301 of the fourth embodiment also reads the conditional sensitivity. Even the same participant may change in sensitivity in combination with the other participants. The conditional sensitivity is the sensitivity based on the combination of participants participating in the communication.

The conditional sensitivity is also calculated from information on the situations of communication that satisfy the predetermined conditions in the same manner as in the case of the conditional behavioral characteristics. That is, in the fourth embodiment, the sensitivity calculator 309 calculates the conditional sensitivity by modeling the relation among the psychological safety, the sensitivity, and the communication environment for each of the situations of communication that satisfy the predetermined conditions. Then, the influence calculator 304 calculates the influences exerted by the participants on one another on the basis of the conditional sensitivity information and the conditional behavioral characteristics information.

The fourth embodiment allows more appropriate advice to be given on the basis of the more detailed conditions (conditional behavioral characteristics and conditional sensitivity that vary depending on the combination of participants, for example) than in the first embodiment.

### Fifth Embodiment

The following describes a fifth embodiment. In the description of the fifth embodiment, the same description as that of the fourth embodiment will not be made, and differences from the fourth embodiment will be described. The fifth embodiment differs from the fourth embodiment in terms of further having a function to display past notifications to the participants and their behavioral characteristics thereafter. That is, the display controller 310 further displays, on the display device, display information (second display information) that includes the relation between the change in the behavioral characteristics of each of the participants and the advices that have been presented as notifications in the past.

### Exemplary Display Information

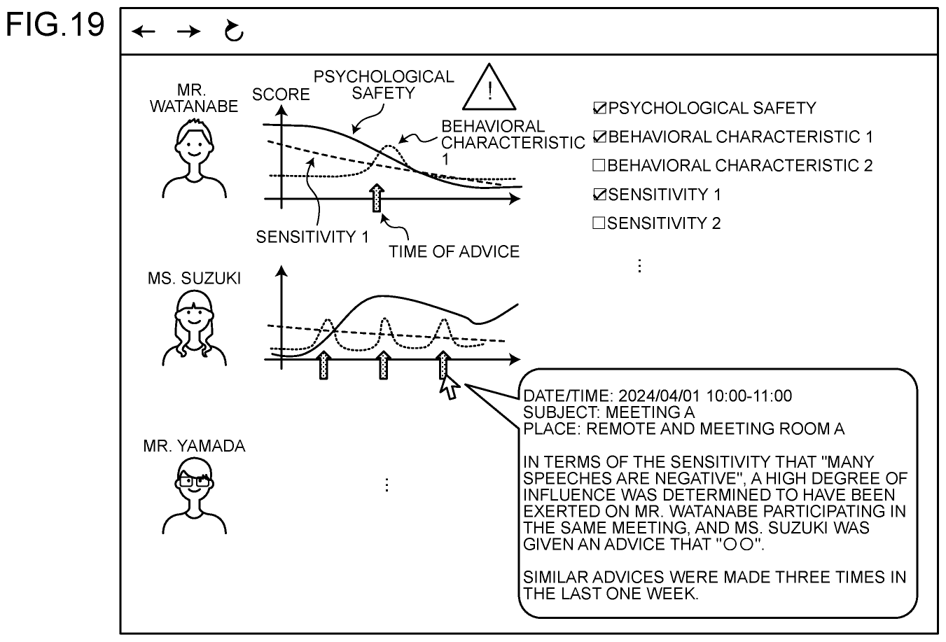

FIG. 19 is a diagram illustrating exemplary display information according to the fifth embodiment. FIG. 19 illustrates an exemplary administration screen that is referred to by a person authorized to check information on the communication of each member of a group (such as an administrator). The administration screen provides a function allowing browsing of the behavioral characteristics of each member of the group and advices presented as notifications by the notifier 306.

The history of the advices recorded in the storage 300 is indicated by arrows, and the details are displayed by a mouse-over operation or clicking on each of the arrows.

Behavioral characteristics 1 and 2 in FIG. 19 represent two different conditional behavioral characteristics. In the same manner, sensitivity 1 and 2 represents two different degrees of conditional sensitivity.

The administration screen illustrated in FIG. 19 may have a function to detect changes in trends of various indicators and raise alerts. In order to detect changes in the trends, a setting screen may further be provided to receive, from the user, detection conditions, such as a drop to a value smaller by a predetermined percentage than a value of the previous day or below.

The fifth embodiment allows easier grasp of, for example, the communication situation of the group. Specifically, the administrator or the like can check the past advices made by the notifier 306 and the changes in behavior after receiving the advices. As a result, the change in the trend of the psychological safety felt by each of the members and members who have repeatedly received advices can be detected earlier.

The following finally describes an exemplary hardware configuration of the information processing device 101 (101-2; 101-3) of the first to the fifth embodiments.

### Exemplary Hardware Configuration

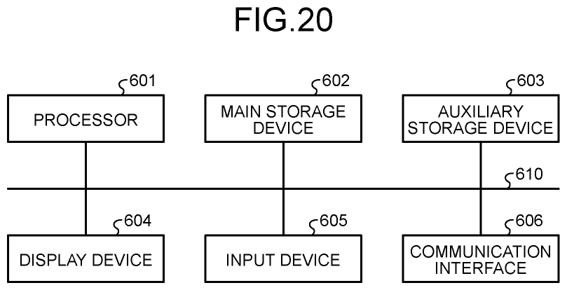

FIG. 20 is a diagram illustrating the exemplary hardware configuration of the information processing device 101 (101-2; 101-3) of the first to the fifth embodiments. The information processing device 101 (101-2; 101-3) includes a processor 601, a main storage device 602, an auxiliary storage device 603, a display device 604, an input device 605, and a communication device 606. The processor 601, the main storage device 602, the auxiliary storage device 603, the display device 604, the input device 605, and the communication device 606 are connected together via a bus 610.

The information processing device 101 (101-2; 101-3) need not include one or some of the components listed above. For example, when the information processing device 101 (101-2; 101-3) can use an input function and a display function of an external device or devices, the information processing device 101 (101-2; 101-3) need not include the display device 604 and the input device 605.

The processor 601 executes the computer program read from the auxiliary storage device 603 to the main storage device 602. The main storage device 602 is a memory such as a read-only memory (ROM) or a random-access memory (RAM). The auxiliary storage device 603 is a hard disk drive (HDD), a memory card, and the like.

The display device 604 is, for example, a liquid crystal display or the like. The input device 605 is an interface for operating the information processing device 101 (101-2; 101-3). The display device 604 and the input device 605 may be implemented by a touchscreen or the like having an input function and a display function. The communication device 606 is an interface for communicating with other devices.

For example, the computer program to be executed on the information processing device 101 (101-2; 101-3) is provided as a computer program product by being recorded as a file having an installable format or an executable format on a computer-readable storage medium such as a memory card, a hard disk, a compact disc-rewritable (CD-RW), a compact disc read-only memory (CD-ROM), a compact disc-recordable (CD-R), a digital versatile disc-random access memory (DVD-RAM), or a digital versatile disc-recordable (DVD-R).

For example, the computer program to be executed on the information processing device 101 (101-2; 101-3) may be stored on a computer connected to a network such as the Internet, and provided by being downloaded via the network.

For example, the computer program to be executed on the information processing device 101 (101-2; 101-3) may be provided via a network such as the Internet without being downloaded. Specifically, the computer program may be provided via, for example, an application service provider (ASP) cloud service.

For example, the computer program for the information processing device 101 (101-2; 101-3) may be provided by being incorporated into a ROM or the like.

The computer program to be executed on the information processing device 101 (101-2; 101-3) has a modular configuration including functions that can also be implemented by the computer program among the functional configurations described above. As the actual hardware, the processor 601 reads the computer program from the storage medium and executes it to load the functional blocks described above as the functions into the main storage device 602. That is, each of the functional blocks described above is generated in the main storage device 602.

One, some, or all of the functions described above may be implemented by hardware such as an integrated circuit (IC), instead of being implemented by software.

More than one of the processors 601 may be used to implement the functions. In that case, each of the processors 601 may implement one of the functions or two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
a hardware processor connected to a memory and configured to:
read, from a storage device, information on sensitivity to psychological safety in a communication environment from a storage device;
read, from the storage device, participant information identifying participants who participate in a first communication;
read, from the storage device, first behavioral characteristics information on each of the participants identified by the participant information;
calculate influences exerted by the participants on one another, the influences being calculated from the information on the sensitivity to the psychological safety and the first behavioral characteristics information;
select, on the basis of the influences, an advice to improve the psychological safety; and
notify a participant to be notified of the advice.

2. The information processing device according to claim 1, wherein the first behavioral characteristics information includes information representing, for each indicator for a property of at least one behavior, a degree of the property of the behavior.

3. The information processing device according to claim 2, wherein the information on the sensitivity to the psychological safety includes information that is evaluated on the basis of the indicator for the property of the behavior of the participant in the communication environment and indicates a degree of increase or decrease in the psychological safety in the communication environment.

4. The information processing device according to claim 1, wherein the hardware processor is further configured to calculate the first behavioral characteristics information on each of the participants, the first behavioral characteristics information being calculated from behavioral data in a second communication performed in the past.

5. The information processing device according to claim 1, wherein the hardware processor is further configured to
acquire the psychological safety felt by each of the participants during the first communication and store the acquired psychological safety in the storage device; and
calculate, after the first communication ends, the information on the sensitivity to the psychological safety by using a psychological safety model obtained by modeling a relation among the psychological safety, an indicator for the communication environment, and the information on the sensitivity to the psychological safety.

6. The information processing device according to claim 1, wherein the hardware processor is further configured to
grasp second behavioral characteristics information representing behavioral characteristics of each of the participants during the first communication, the second behavioral characteristics being grasped from states of the participants during the first communication, and
select the advice when the second behavioral characteristics information exhibits a change exceeding a threshold that is set on the basis of the first behavioral characteristics information.

7. The information processing device according to claim 1, wherein the hardware processor is further configured to adjust the advice to be presented as the notification to the participant to be notified, the advice being adjusted on the basis of whether a change in behavioral characteristics of the participant to be notified has occurred between before and after the notification of the advice.

8. The information processing device according to claim 1, wherein the hardware processor is further configured to
read conditional behavioral characteristics information based on a combination of the participants participating in the first communication,
read conditional sensitivity information based on the combination of the participants participating in the first communication, and
calculate the influences exerted by the participants on one another, the influences being calculated on the basis of the conditional sensitivity information and the conditional behavioral characteristics information.

9. The information processing device according to claim 1, wherein the hardware processor is further configured to display, on a display device, first display information on which an icon highlighting the notification is superimposed when the influence exceeds a predetermined degree.

10. The information processing device according to claim 9, wherein the hardware processor is further configured to display, on the display device, second display information including a relation between a change in the behavioral characteristics of each of the participants and the advice presented as the notification in the past.

11. A computer program product comprising a non-transitory computer-readable recording medium on which a program executable by a computer is recorded, the program instructing the computer to:
read, from a storage device, information on sensitivity to psychological safety in a communication environment from a storage device;
read, from the storage device, participant information identifying participants who participate in a first communication;
read, from the storage device, first behavioral characteristics information on each of the participants identified by the participant information;
calculate influences exerted by the participants on one another, the influences being calculated from the information on the sensitivity to the psychological safety and the first behavioral characteristics information;
select, on the basis of the influences, an advice to improve the psychological safety; and
notify a participant to be notified of the advice.

12. An information processing method implemented by a computer, the method comprising:
reading, from a storage device, information on sensitivity to psychological safety in a communication environment from a storage device;
reading, from the storage device, participant information identifying participants who participate in a first communication;
reading, from the storage device, first behavioral characteristics information on each of the participants identified by the participant information;
calculating influences exerted by the participants on one another, the influences being calculated from the information on the sensitivity to the psychological safety and the first behavioral characteristics information;
selecting, on the basis of the influences, an advice to improve the psychological safety; and
notifying a participant to be notified of the advice.
